(19) United States
(12) Patent Application Publication
(10) Pub. No.: US 2019/0135593 A1
(43) Pub. Date: May 9, 2019

(54) HOIST ASSEMBLY DRUM

(71) Applicant: Wenger Corporation, Owatonna, MN (US)

(72) Inventors: John E. Titus, Lonsdale, MN (US); Edwin W. Bolz, Queensbury, NY (US); Christopher D. Whaley, Phoenix, NY (US); Paul W. Zagajeski, Liverpool, NY (US)

(21) Appl. No.: 16/181,459

(22) Filed: Nov. 6, 2018

Related U.S. Application Data
(60) Provisional application No. 62/582,589, filed on Nov. 7, 2017.

(51) Int. Cl. B66D 1/30; B66D 1/26

(52) U.S. Cl. CPC B66D 1/30; B66D 1/26

(57) ABSTRACT

An innovative drum for use with a hoist assembly is disclosed. The drum incorporates a layered rope design wherein each layer utilizes the support of the subsequent layer for accurate positioning of individual wraps. Multiple lines are achieved by combining any number of individual drums together along a support structure.

### CROSS-REFERENCE TO RELATED APPLICATION

The present application claims the benefit of U.S. Provisional Application No. 62/582,589, filed Nov. 7, 2017, which is hereby incorporated herein in its entirety by reference.

### TECHNICAL FIELD

The present invention relates to a drum for use with a hoist assembly.

### BACKGROUND

The use of hoists for lifting and lowering items is well known. Hoists commonly utilize a drum for reeling in the rope, wire, or cable used for the lifting and lowering of items. It is well known to those skilled in the art that controlling the spooling of the rope, wire, or cable is desired to maintain uniformity in operation of the hoist and to provide smooth coiling and uncoiling of the rope, wire, or cable.

There is a propensity for the rope, wire, or cable to bunch and overlap on the previous coil or along the outer rim of the drum. This may lead to later coils to slip or jump when the drum is being unwound (lowering). The slipping and jumping of the coil results in uneven release of the rope, wire, or cable and jarring of the item being lowered. Not only is this undesirable from an operation standpoint, but it can further result in damage to the item being lowered. The slipping and jumping of the rope, wire, or cable is more pronounced when multiple lines are used to raise and lower an item, because the multiple lines will unreel at different speeds.

While prior art devices have attempted to address the issue of consistent and repeatable stacking and alignment of rope, wire, or cable in hoist systems, there exists a desire for a more accurate means of consistent lifting and lowering using a hoist.

### SUMMARY

The present invention is directed to an improved drum for use with a hoist assembly. The drum incorporates a layered rope design wherein each layer utilizes the support of the subsequent layer for accurate positioning of individual wraps. Multiple lines are achieved by combining any number of individual drums together along a support structure.

The drum incorporates a layered rope design wherein each layer utilizes the support of the subsequent layer for accurate positioning of individual wraps of rope, wire, or cable. A wrap is defined as a single complete revolution of the drum permitting the rope or cable to traverse the drum diameter completely.

Multiple lines may be handled by one hoist by combining any number of individual drums together along a support structure. When using multiple drums, each drum is separated by a segment plate and the outside of the drum assembly is also completed by a segment plate at each end.

The above summary is not intended to describe each illustrated embodiment or every implementation of the subject matter hereof. The figures and the detailed description that follow more particularly exemplify various embodiments.

### ADVANTAGES OF THE INVENTION

Allows for more compact wrapping of rope, wire, or cable, thus minimizing the overall size of the hoist system.
Each wrap is fully supported with an integrated feature from each side at the first wrap and last wrap of each layer.
Provides more consistent and repeatable stacking and alignment, which allows for consistent lifting/lowering by hoist.
Side supports provide accurate stacking as well as alignment of each complete layer.

### BRIEF DESCRIPTION OF THE DRAWINGS

Subject matter hereof may be more completely understood in consideration of the following detailed description of various embodiments in connection with the accompanying figures, in which:

FIG. 1 is a top view of a hoist drum assembly according to an embodiment of the invention.

FIG. 2 is a cross-sectional view of the hoist drum assembly of FIG. 1 taken along line A-A.

FIG. 3 is a detail view of the hoist drum assembly of FIG. 1 taken at arc B-B.

FIG. 4 is a detail view of the hoist drum assembly of FIG. 1 taken at arc C-C.

FIG. 5 is a front view of a hoist drum assembly according to an embodiment of the invention.

FIG. 6 is a perspective view of the hoist drum assembly of FIG. 5.

FIG. 7 is a left side view of the hoist drum assembly of FIG. 5.

FIG. 8 is a cross-sectional view of the hoist drum assembly of FIG. 5 taken along line D-D.

FIG. 9 is a detail view of the hoist drum assembly of FIG. 5 taken at arc E-E.

FIG. 10 is a left side view of a hoist drum according to an embodiment of the invention.

FIG. 11 is a front view of the hoist drum of FIG. 10.

FIG. 12 is a top view of the hoist drum of FIG. 10.

FIG. 13 is a bottom view of the hoist drum of FIG. 10.

FIG. 14 is a cross-sectional view of the hoist drum of FIG. 11 taken along line F-F.

FIG. 15 is a cross-sectional view of the hoist drum assembly of FIG. 10 taken along line G-G.

FIG. 16 is a cross-sectional view of the hoist drum of FIG. 10 taken along line H-H.

FIG. 17 is a cross-sectional view of the hoist drum of FIG. 10 taken along line I-I.

FIG. 18 is a perspective view of a hoist incorporating a hoist drum assembly according to an embodiment of the invention.

FIG. 19 is a perspective view of a hoist incorporating a hoist drum assembly according to an embodiment of the invention.

FIG. 20 is a perspective view of a hoist incorporating a hoist drum assembly according to an embodiment of the invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

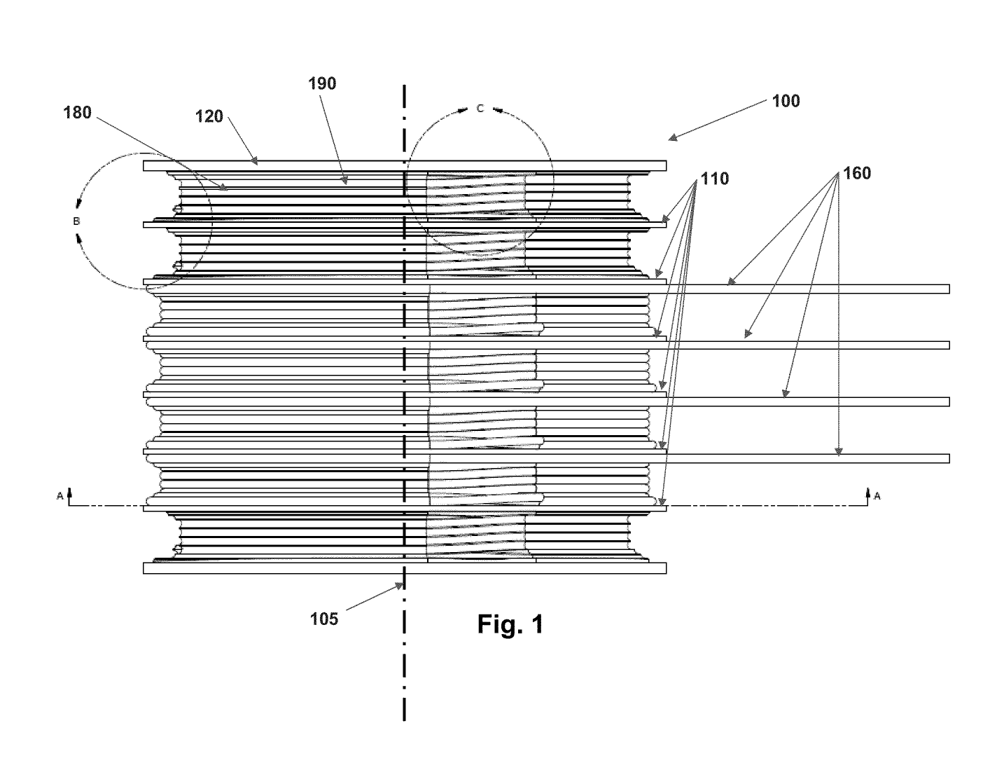

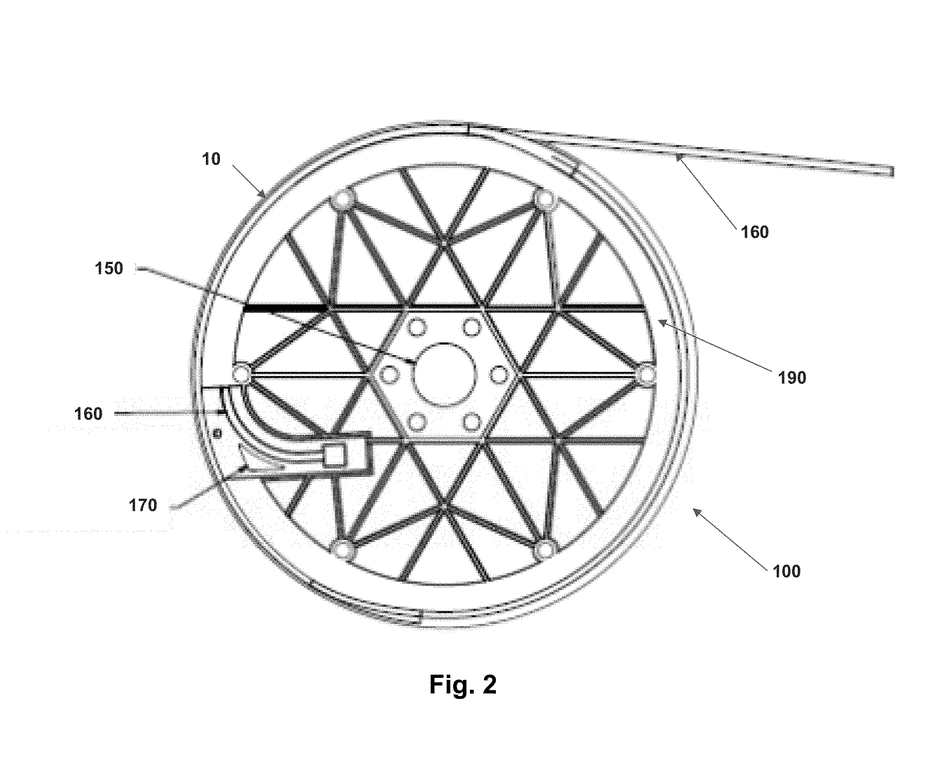

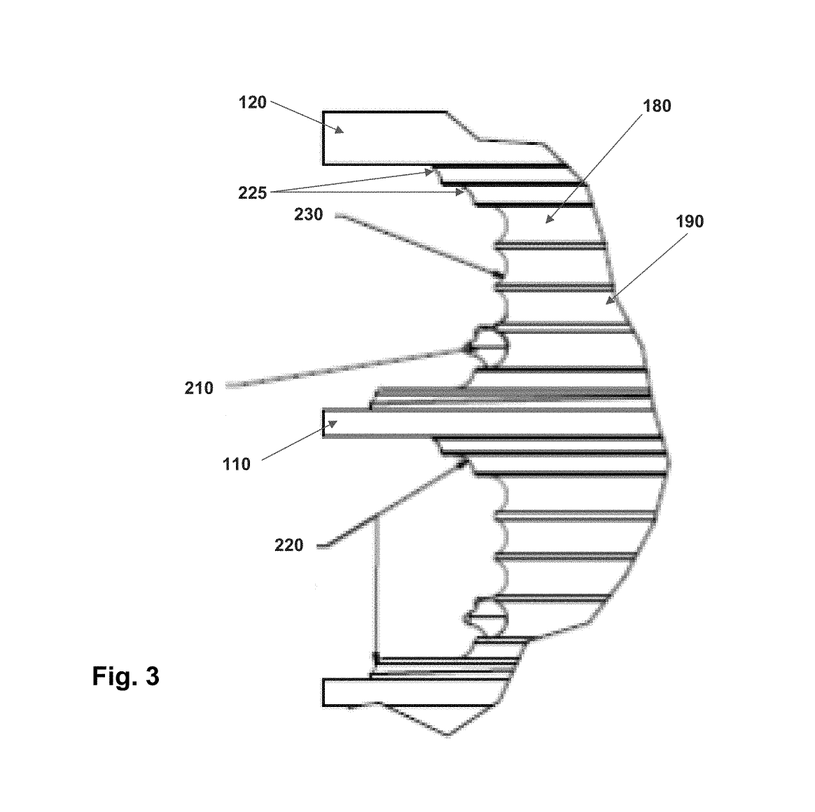

A hoist drum assembly according to an embodiment of the invention is depicted generally in FIG. 1 with reference numeral 100. In the embodiment depicted in FIG. 1, the hoist drum assembly 100 consists of seven drums 10, each drum 10 is intended to spool a single cable 160 around a drum body 190 having a drum body axis 105. FIG. 2 presents a cross-sectional view of the same embodiment as shown in FIG. 1. The drum assembly 100 is comprised of one or more drums 10 for spooling a cable 160 around its periphery along a helical groove 180 (see FIG. 3). The helical groove 180 is dimensioned to accommodate one winding of the cable 160 and includes a base support 230 that guides the first layer of cable 160 to establish the desired overlap characteristics. Each drum 10 includes inner drum side plates 110 that act to keep each cable 160 within its specified drum 10. End plates 120 are used to sandwich multiple drums 10 together for multi-line hoists.

As illustrated in FIG. 3, each drum 10 has a wire rope entry 210 that allows the cable 160 to exit the interior of the drum 10 at a specific location against the side support 220 of the drum 10. As seen in FIG. 1, the cable 160 enters the interior of the drum 10 and is fixed by a cable capture insert 170. The cable capture insert 170 locks the end of the cable 160 to the drum 10.

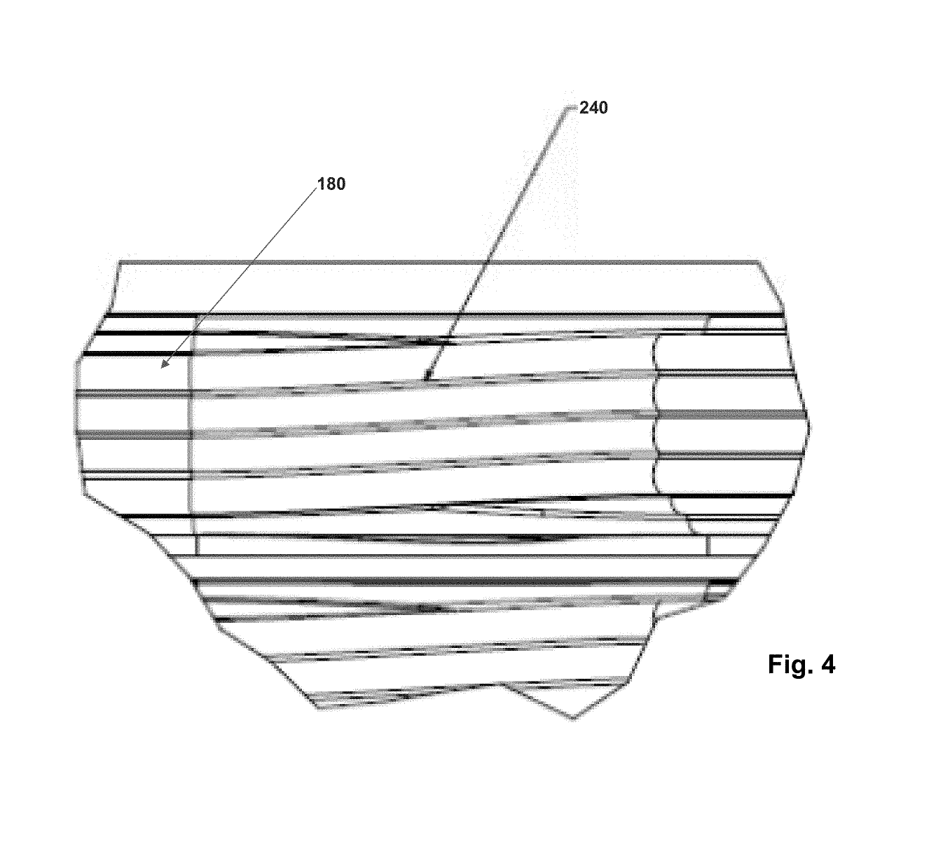

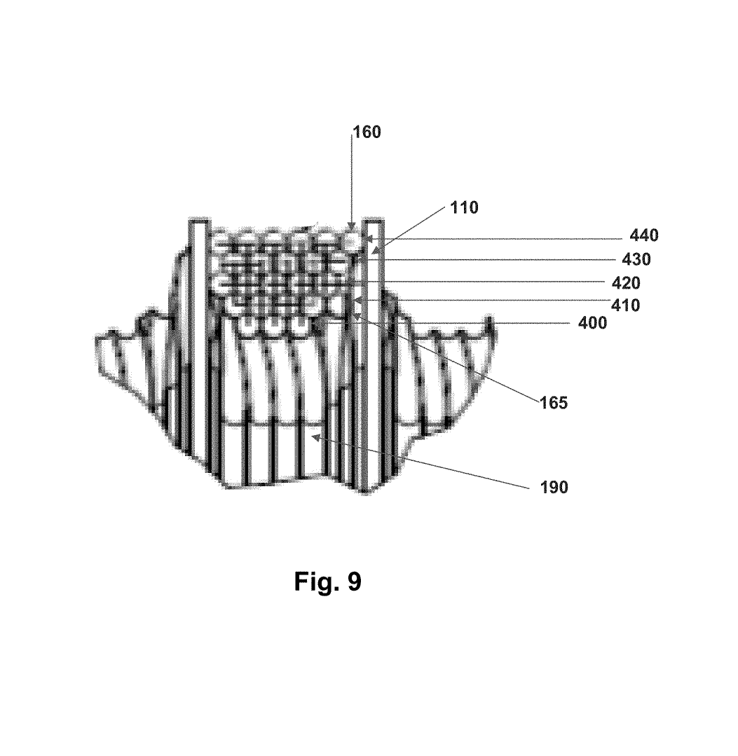

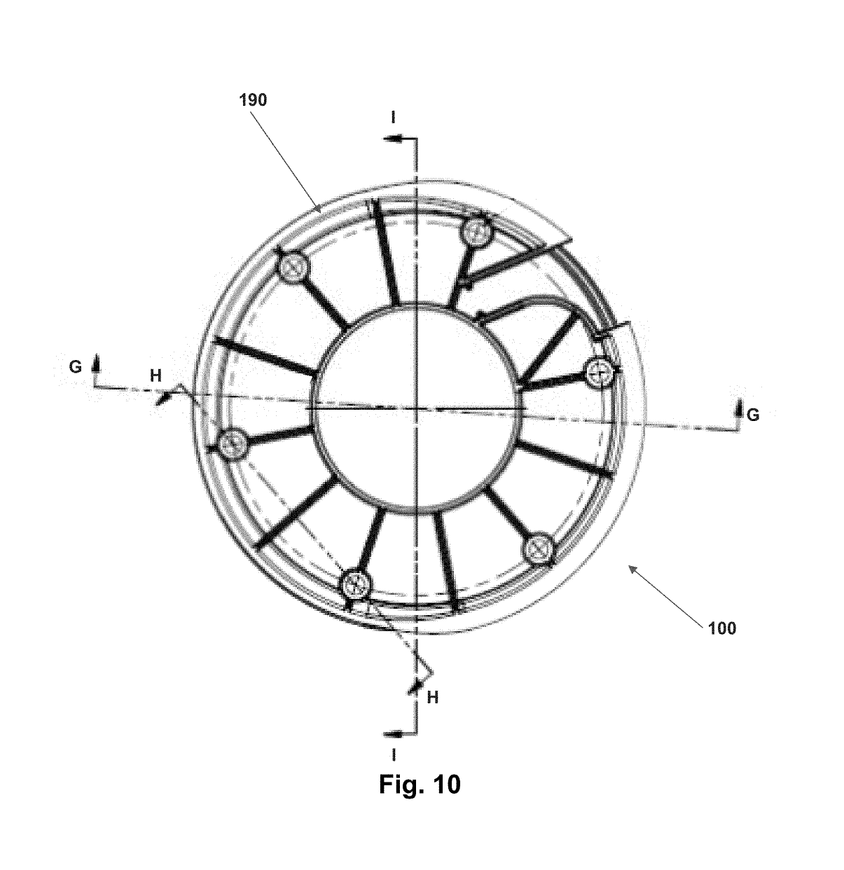

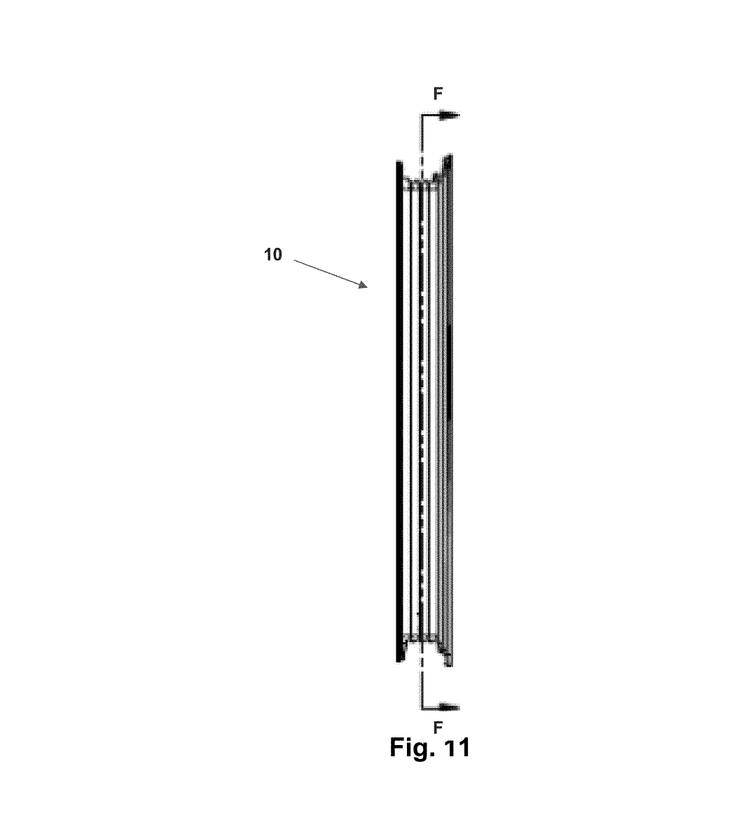

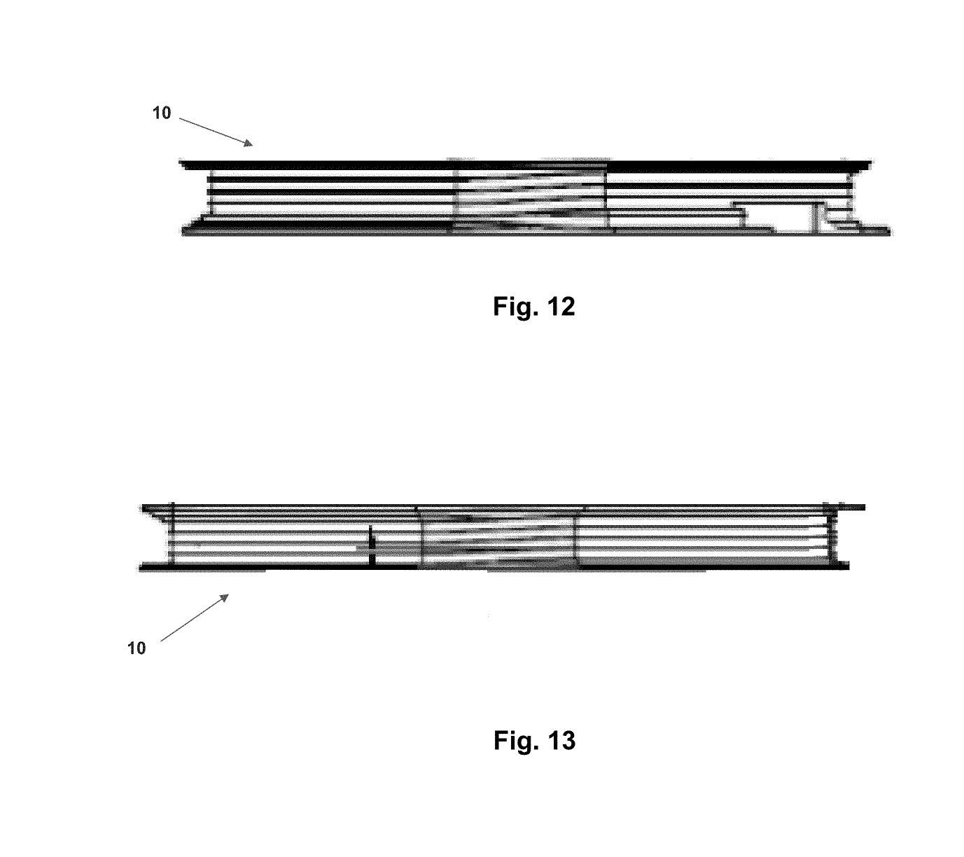

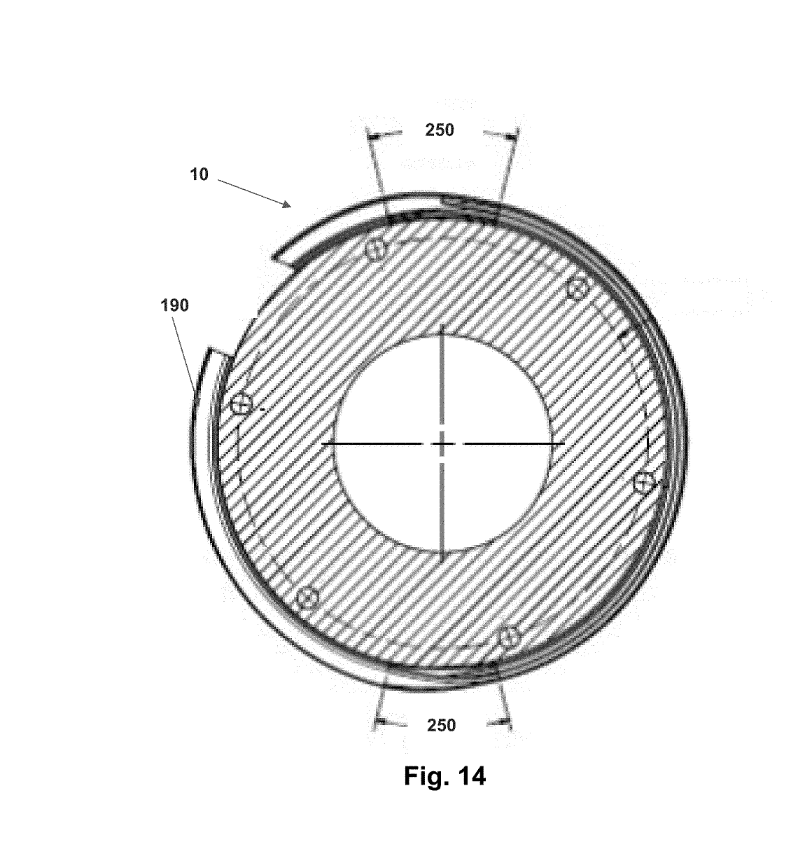

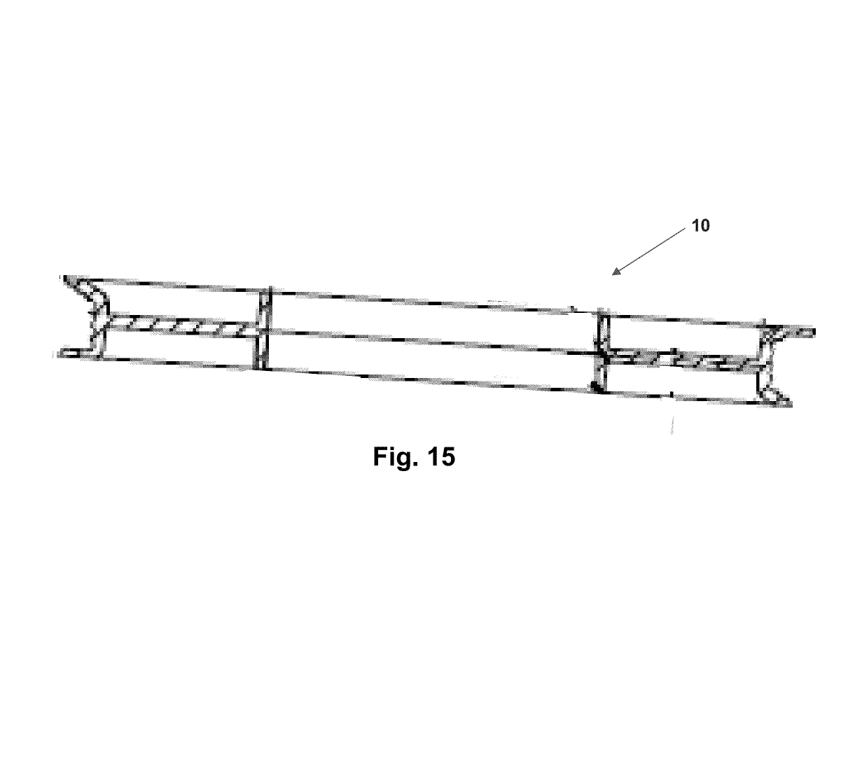

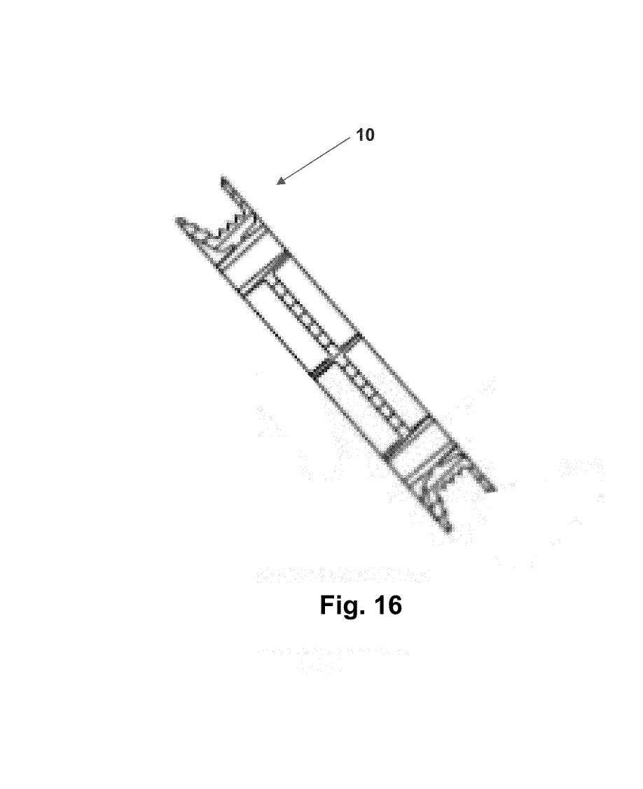

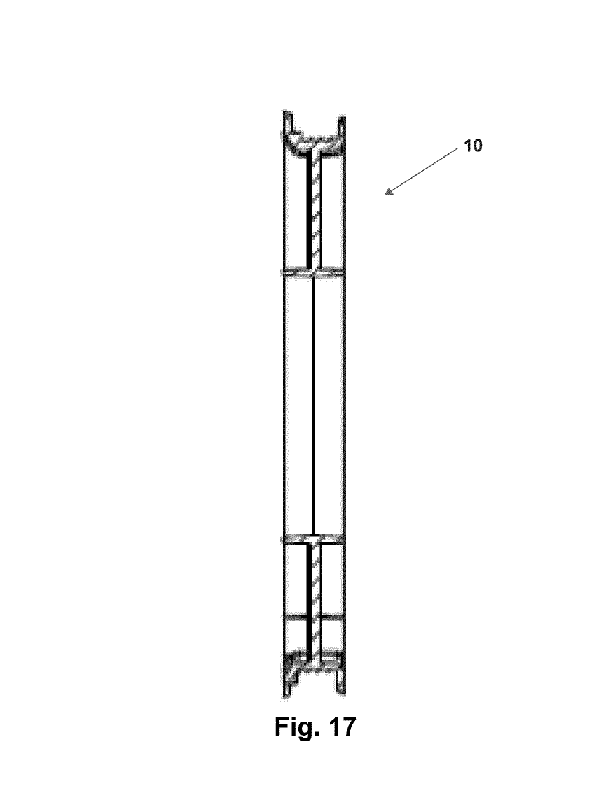

To secure the cable 160 on the drum 10 for consistent and repeatable wrapping, the drum 10 includes side supports 220 that are sized and positioned to fully support subsequent layers of cable 160 wrapped on the drum after the initial layer. The side supports 220 utilize channels 225 that are sized to fit the diameter of the cable 160. FIG. 4 illustrates that each groove 180 includes two transition sections 240 located 157 degrees apart from each other that offsets the wrap of the cable 160 by a complete cable 160 diameter. Thus, when a cable 160 passes two transition sections 240 having a transition angle 250, the drum 10 forces the cable 160 to the left and then to the right to control the wrapping. As shown in FIG. 9, this configuration results in exact placement of the cable for the first layer 400, second layer, 410, third layer 420, fourth layer 430, and so on.

As can be seem in FIG. 3, the precision of the hoist assembly drum 100 is further enhanced by side supports 220 that buttress the cable 160 when the wrap reaches the last wrap for each layer of cable 160 and restricts the first wrap of the next layer to align in the optimum position.

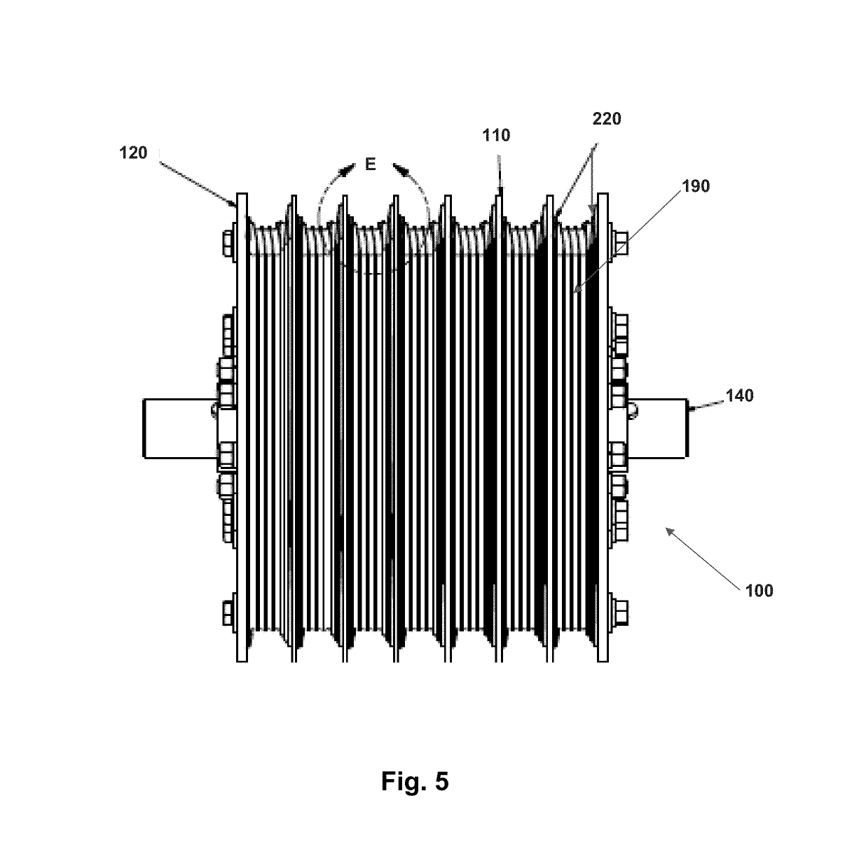

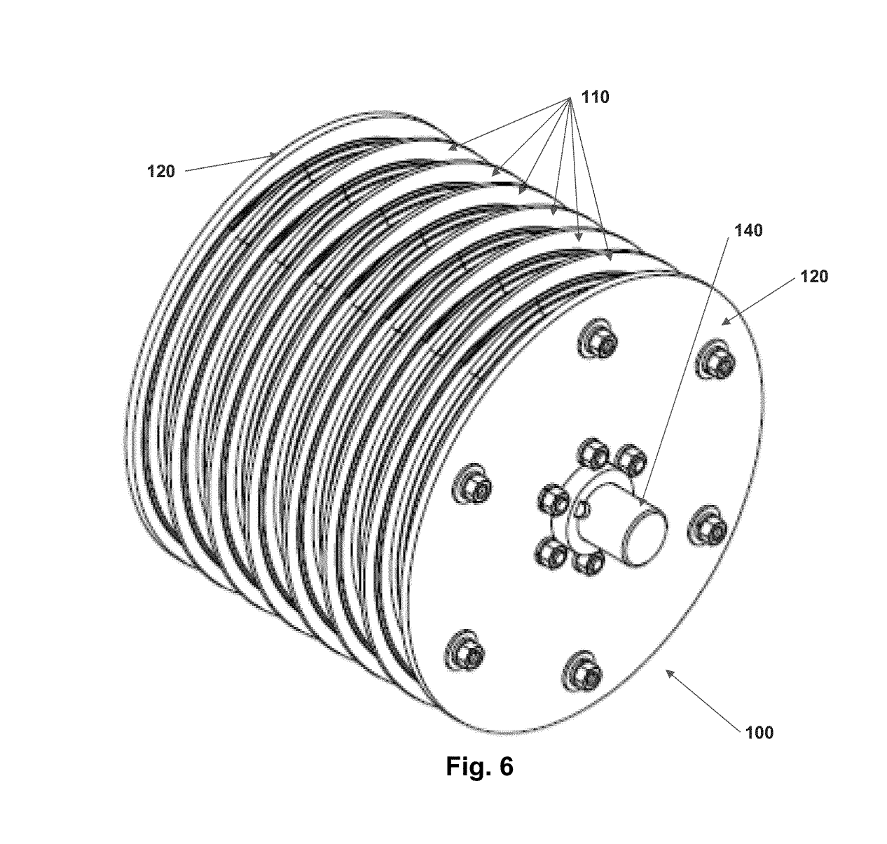

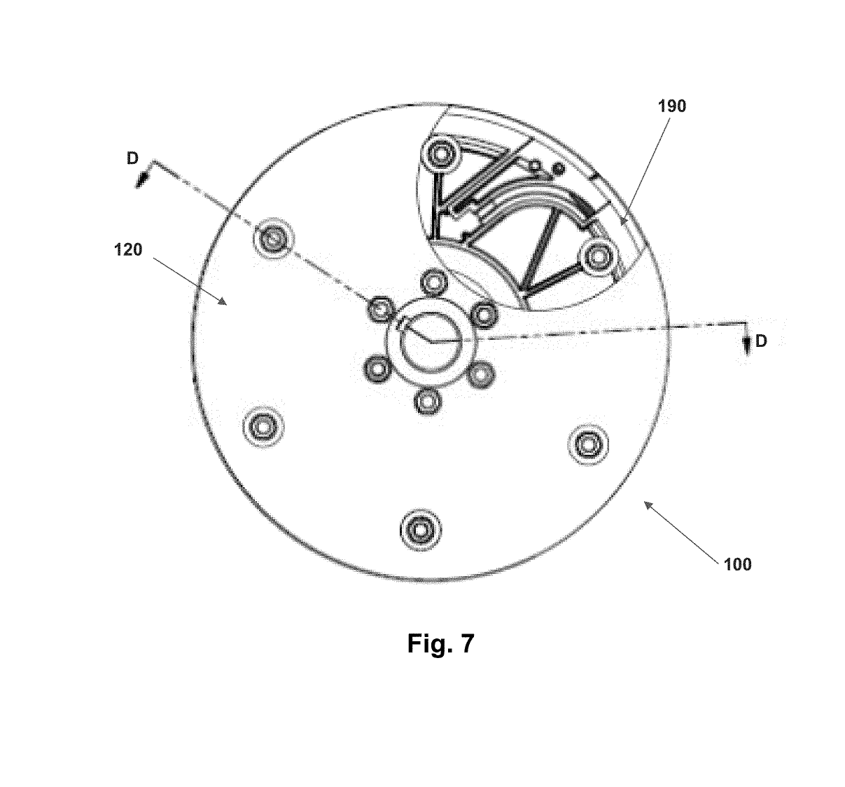

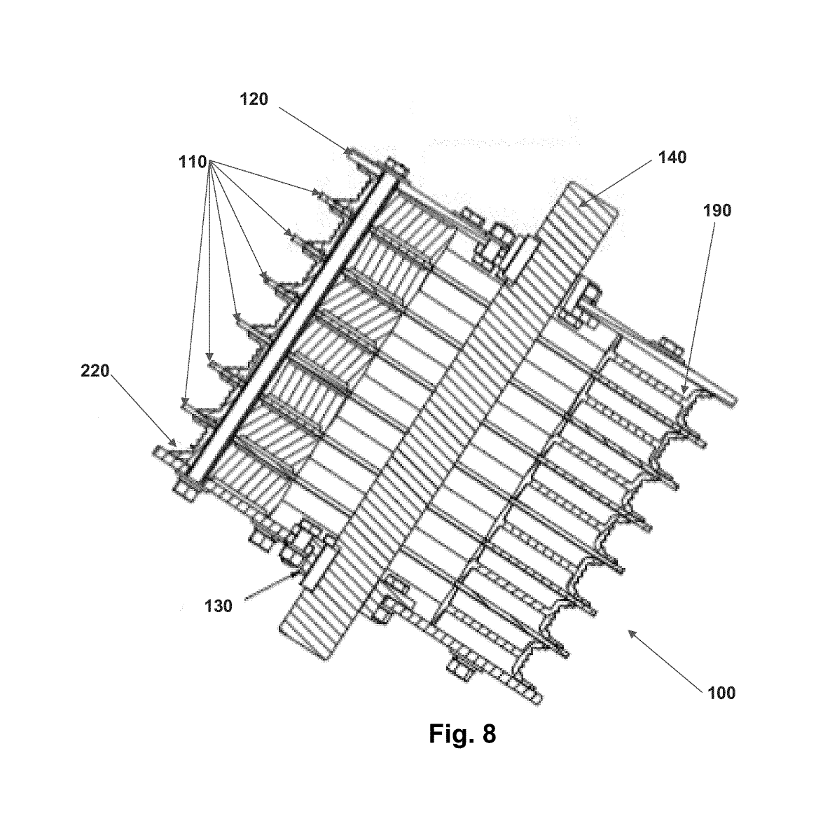

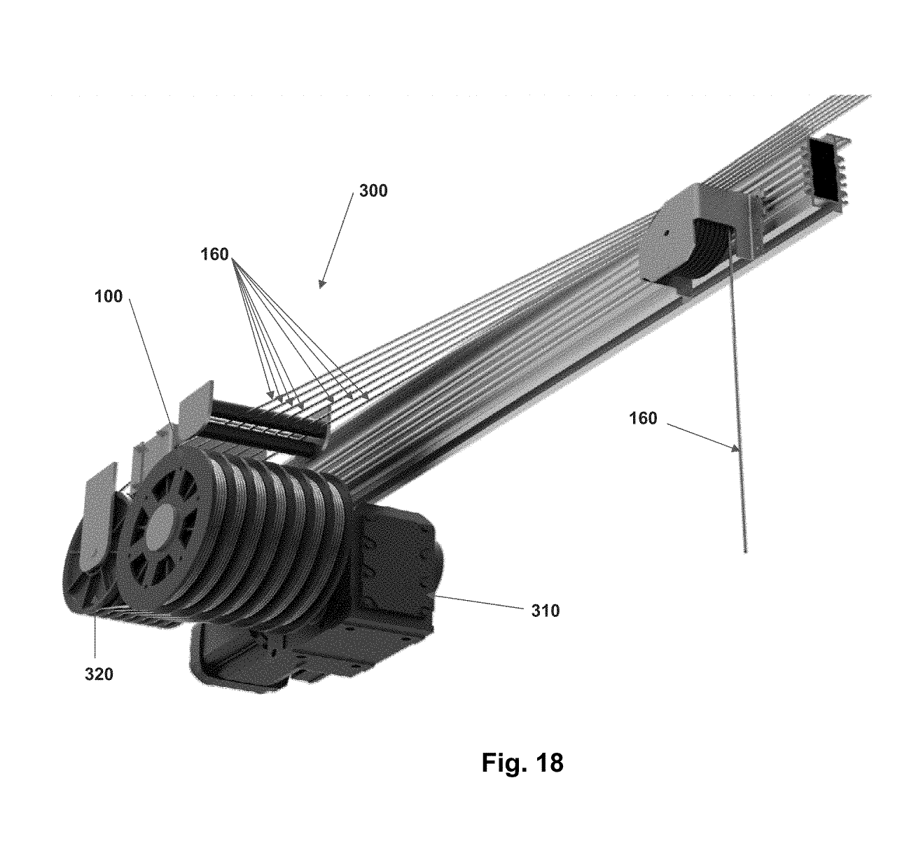

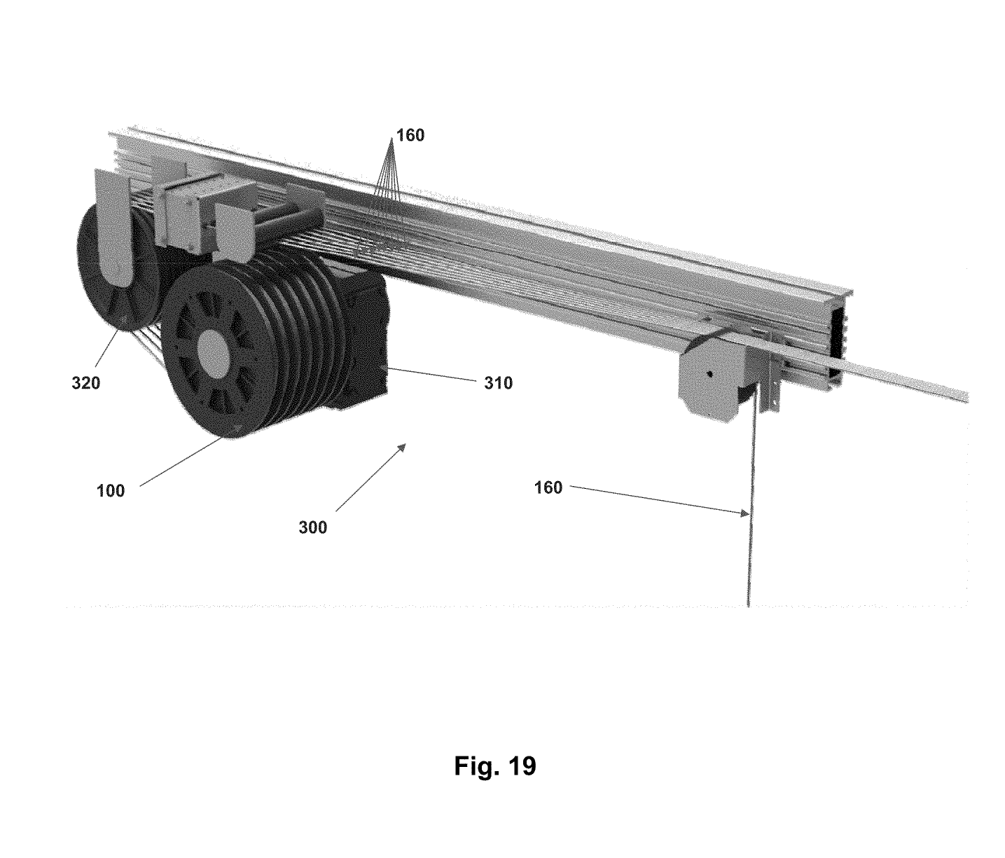

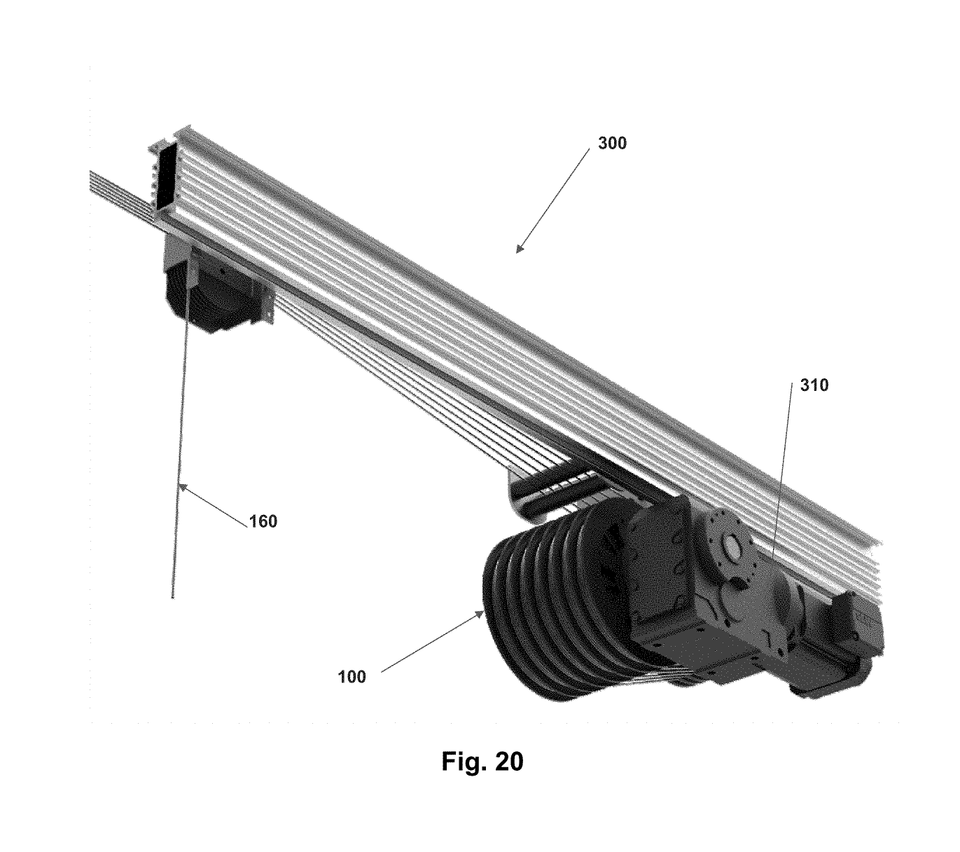

Multiple cables 160 may be handled by one hoist 300 by combining any number of drums 10 together along a drive shaft 140 (see FIGS. 5-6, 8) running through the drive core 150 of each drum 10. While the preferred embodiment contemplates a hoist 300 comprising multiple drums 10 making up the hoist drum assembly 100 and a single hoist motor 310 as shown in FIGS. 18-20, multiple motors 310 can be utilized. A take-up pulley 320 may also be used to assist in spooling the cable 160.

The preferred embodiment considers manufacturing the drum 10 of nylon 6/6 glass filled with 5% regrind allowed, 11-inch diameter. While this material is preferred, those of ordinary skill in the art will recognize that different materials and compounds may be used to obtain varying performance and durability requirements.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

We claim:

1. A hoist drum comprising:
an inner drum side plate;
a drum body comprising:
a cable entry;
a helical groove;
first and second transition sections;
first and second side supports.

2. The hoist drum of claim 1 wherein the helical groove allows a cable having a cable diameter to coil around the drum body when the drum body is rotated.

3. The hoist drum of claim 2 wherein the helical groove comprises a base support shape.

4. The hoist drum of claim 3 wherein the cable entry introduces the cable into the helical grove with an exterior edge of the cable against the first side support.

5. The hoist drum of claim 4 wherein the helical groove coils the cable in a first layer wherein the cable abuts itself upon successive coils in a plane until the cable reaches the second side support.

6. The hoist drum of claim 5 wherein the second side support comprises a channel.

7. The hoist drum of claim 6 wherein the channel is sized to fittingly receive the cable.

8. The hoist drum of claim 7 wherein the channel is positioned whereupon further rotation of the drum body forces the cable to coil onto a next level.

9. The hoist drum of claim 8 wherein the channel is positioned such that the first coil of the second level is offset one half the cable diameter beyond the last coil of the first level.

10. The hoist drum of claim 9 wherein the drum body has an axis and the channel is positioned such that the second level is offset one half the cable diameter away from the drum body axis.

11. The hoist drum of claim 10 wherein the first and second transition sections are offset by an angle of 145-165 degrees.

12. The hoist drum of claim 10 wherein the first and second transition sections occur over an arc of 20-35 degrees of the drum body.

13. A hoist drum assembly comprising a plurality of hoist drums of claim 1.

14. Hoist comprising:
a hoist motor;
a plurality of hoist drums, each hoist drum comprising;
a drum body comprising:
a cable entry;
a helical groove;
first and second transition sections;
first and second side supports;
wherein each helical groove coils a cable in a first layer wherein the cable abuts itself upon successive coils in a plane until each cable reaches the second side support.

15. The hoist of claim 16 wherein each second side support comprises a channel sized to fittingly receive a cable and the channel is positioned whereupon rotation of the hoist drums forces each cable to coil onto a next level.

17. The hoist of claim 16 wherein the first and second transition sections are offset by an angle of 145-165 degrees.

18. The hoist of claim 17 wherein the first and second transition sections occur over an arc of 20-35 degree of the drum body.

19. The hoist of claim 18 further comprising a take up pulley.

20. The hoist of claim 19 wherein the plurality of hoist drums has a shared axis and each channel is positioned such that the second level is offset one half the cable diameter away from the drum body axis.
